(19) United States
(12) Patent Application Publication
(10) Pub. No.: US 2017/0323316 A1
(43) Pub. Date: Nov. 9, 2017

(54) Method for Documenting a Customer's Journey Using an Online Survey Platform

(71) Applicant: Joseph Wheeler, Hingham, MA (US)

(72) Inventor: Joseph Wheeler, Hingham, MA (US)

(21) Appl. No.: 15/588,611

(22) Filed: May 6, 2017

Related U.S. Application Data
(60) Provisional application No. 62/332,704, filed on May 6, 2016.

(51) Int. Cl. G06Q 30/02; G06Q 10/06; H04L 29/08

(52) U.S. Cl. CPC G06Q 30/0203; G06Q 10/06393; H04L 67/306; H04L 67/10

(57) ABSTRACT

A method for documenting a customer's journey using an online survey platform has an administrator account and a plurality of user profiles, each of which are managed by a remote server and are also associated with corresponding PC devices. The method begins by receiving a project creation request from the administrator account. The project creation request initiates the survey creation process. Next, a survey template is created to function as the framework around which the survey is structured. The survey template is then formatted to contain the appropriate questions that gauge user experience while moving through the phases of a task. The formatted survey template is sent multiple user profiles. The user associated to those profiles then respond to the survey. Finally, the responses are analyzed and the results of the analysis is presented to the administrator account.

The current application claims a priority to the U.S. Provisional Patent application Ser. No. 62/332,704 filed on May 6, 2016.

### FIELD OF THE INVENTION

The present invention generally relates to a commercial customer relationship management (CRM) software. In particular, the present invention relates to a system and method which provides organizations with a unique software platform to identify “pain points” in the customer journey, as well as areas that could represent significant competitive advantages.

### BACKGROUND OF THE INVENTION

Today's business environment requires companies to pay attention to the experience they deliver to their customers. To remain competitive, leading organizations employ software tools to ensure the improvements that they make to the experience are things that are valuable to their customers and help them sustain a competitive advantage. Unfortunately, the current set of tools and technologies that exist make it a challenge to collect data that can accurately inform the top priorities for improvement to users in a timely fashion. As well, current tools force researchers to make compromises that can create less than optimal results based on limited sample sets available to them, due to self-imposed constraints of time, money, and other resources.

It is therefore an objective of the present invention to introduce a system and method for mapping the customer journey and capturing real time data using mobile devices. The present invention utilizes a new software platform called the, “CX Workout.” The software provides organizations with a unique software platform to identify “pain points” in the customer journey, as well as areas that could significant competitive advantages. The software accomplishes this through a combination of proprietary steps, technologies, and mathematical algorithms.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a process for integrating the project description into the survey template through the method of the present invention.

FIG. 4 is a flowchart describing a process for inputting the project evaluation metric into the response evaluation process through the method of the present invention.

FIG. 5 is a flowchart describing a process for setting up an automated survey dissemination process through the method of the present invention.

FIG. 6 is a flowchart describing a process for selecting the contact profiles that will receive surveys through the method of the present invention.

FIG. 7 is a flowchart describing a process for executing the formatting process through the method of the present invention.

FIG. 8 is a flowchart describing a process for selecting a phase from a group of predefined phases through the method of the present invention.

FIG. 9 is a flowchart describing a process for creating a unique phase through the method of the present invention.

FIG. 10 is a flowchart describing a process for selecting at least one survey question from a group of predefined survey questions through the method of the present invention.

FIG. 11 is a flowchart describing a process for creating a unique survey question through the method of the present invention.

FIG. 12 is a flowchart describing a process for selecting a process-defining action from a group of predefined process-defining actions through the method of the present invention.

FIG. 13 is a flowchart describing a process for creating a unique process-defining action through the method of the present invention.

FIG. 14 is a flowchart describing a process for receiving a set of responses from a user through the method of the present invention.

FIG. 15 is a flowchart describing a process for receiving annotative content from a user through the method of the present invention.

FIG. 16 is a flowchart describing a process for executing the response evaluation process through the method of the present invention.

FIG. 17 is a flowchart describing a process for integrating the aggregate phase score into the summarization interface through the method of the present invention.

FIG. 18 is a flowchart describing a process for integrating the user-based analysis report into the summarization interface through the method of the present invention.

FIG. 19 is a flowchart describing a process for integrating the user-based comparison report into the summarization interface through the method of the present invention.

FIG. 20 is a flowchart describing a process for integrating a set of annotations from an external contact into the summarization interface through the method of the present invention.

FIG. 21 is a flowchart describing a process for integrating a set of annotations from the administrator account into the summarization interface through the method of the present invention.

FIG. 22 is a flowchart describing a process for initiating a supplementary communication process through the method of the present invention.

### DETAIL DESCRIPTIONS OF THE INVENTION

All illustrations of the drawings are for the purpose of describing selected versions of the present invention and are not intended to limit the scope of the present invention.

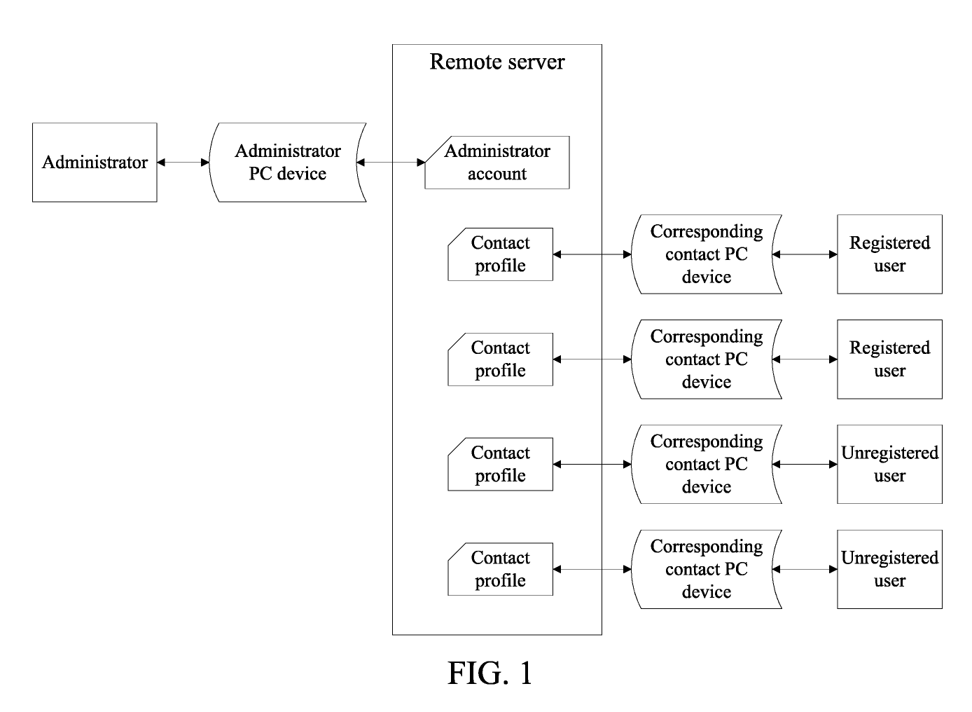

As can be seen in FIG. 1 through FIG. 22, the preferred embodiment of the present invention, the method for documenting a customer's journey using an online survey platform, uses a system that enables an administrator to generate surveys that quantify one or more user's experience performing a specific task. Additionally, the present invention is a system that enables the administrator to analyze the dataset that is generated by the users' responses to the survey. The present invention analyzes a user's experience by breaking down the task into discrete phases. The administrator recognizes that the user must perform specific actions to move from one phase to the next. As such, the administrator uses the present invention to generate questions that are designed to quantify the user's experience performing the specific actions. In addition to user experience, the present invention is designed to determine the value that the user derives from moving through the phases of the task. Generating and evaluating surveys is but one aspect of the present invention. Another aspect is the ability to share survey data with experts and colleagues. As such, the present invention functions as an ecosystem for user-experience optimization.

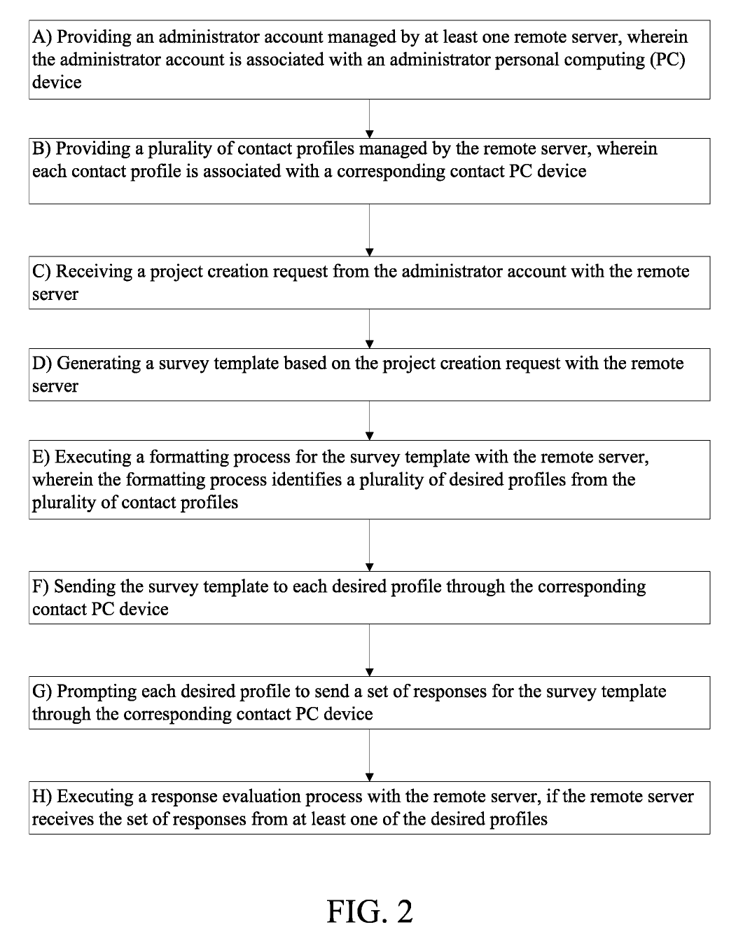

As can be seen in FIG. 2, the system used to execute the method of the present invention allows the present invention to function as an administrator's tool for quantifying the experience of a plurality of users in a manner that yields actionable data sets. Consequently, the method of the present invention identifies the administrator with a unique administrator account that is managed by at least one remote server. The administrator account allows the administrator to generate and disseminate surveys, review survey results, and dialog about survey data with colleagues and survey respondents. In the system used to interact with the present invention, the administrator account is associated with an administrator personal computing (PC) device (Step A). Similarly, the method of the present invention is used to manage the actions taken by a plurality of users who receive the survey. To accomplish this, the method of the present invention associates each of the plurality of users with a corresponding contact profile from a plurality of contact profiles that is managed by the remote server (Step B). Additionally, each of the contact profiles is associated with a corresponding contact PC device. The administrator PC device and the corresponding contact PC device can be, but are not limited to, a smart-phone, a laptop, a desktop, or a tablet PC. The remote server is used to facilitate communication between the administrator account and the plurality of contact profiles. Moreover, the remote server is used to execute a number of internal processes for the present invention and is used to store survey data.

As can be seen in FIG. 2, the overall process followed by the method of the present invention allows the administrator to generate, distribute, and evaluate surveys. The overall process of the present invention begins by receiving a project creation request from the administrator account with the remote server (Step C). The project generation request is a command that the administrator issues to direct the present invention to initiate the process of creating a survey. Additionally, the project generation request includes data that denotes specific information about the survey. For example, the project generation request could contain information that specifies the metric that will be used to evaluate the survey and a description of the survey. The overall process of the present invention continues by generating a survey template based on the project creation request with the remote server (Step D). The survey template is an interface that serves as the framework around which the survey is created. The overall process of the present invention continues by executing a formatting process for the survey template with the remote server (Step E). The formatting process is made up of a series of sub-processes that work in concert to incorporate information into the survey template. As a result of the formatting process, the survey template is modified to contain all of the questions and information that the administrator wishes to be present in the generated survey. Additionally, the formatting process identifies a plurality of desired profiles from the plurality of contact profiles. Each of the desired profiles is a contact profile that the administrator selects as a recipient of the generated survey. That is, the administrator specifies a set of users that will be surveyed by the present invention.

As can be seen in FIG. 2, once the survey template is formatted, the administrator is then ready to distribute the survey to the set of users that will be surveyed. The overall process of the present invention continues by sending the survey template to each desired profile through the corresponding contact PC device (Step F). This step is used to make the survey available to each user in the set of users that will be surveyed. Furthermore, each user is able to access the survey through a corresponding contact PC device. The overall process of the present invention continues by prompting each desired profile to send a set of responses for the survey template through the corresponding contact PC device (Step G). The set of responses is the data that contain each of the user's responses to the questions included in the survey. Once the user has completed the survey, the method of the present invention prompts the user to submit the responses so that the data can be added to a repository of responses from survey respondents. The overall process of the present invention continues by executing a response evaluation process with the remote server, if the remote server receives the set of responses from at least one of the desired profiles. The response evaluation process is a collection of sub-processes that enable the administrator to perform analysis, statistical or otherwise, on the repository of responses from the survey respondents. Additionally, the response evaluation process enables the administrator to send the results of the survey analysis to colleagues and subject matter experts.

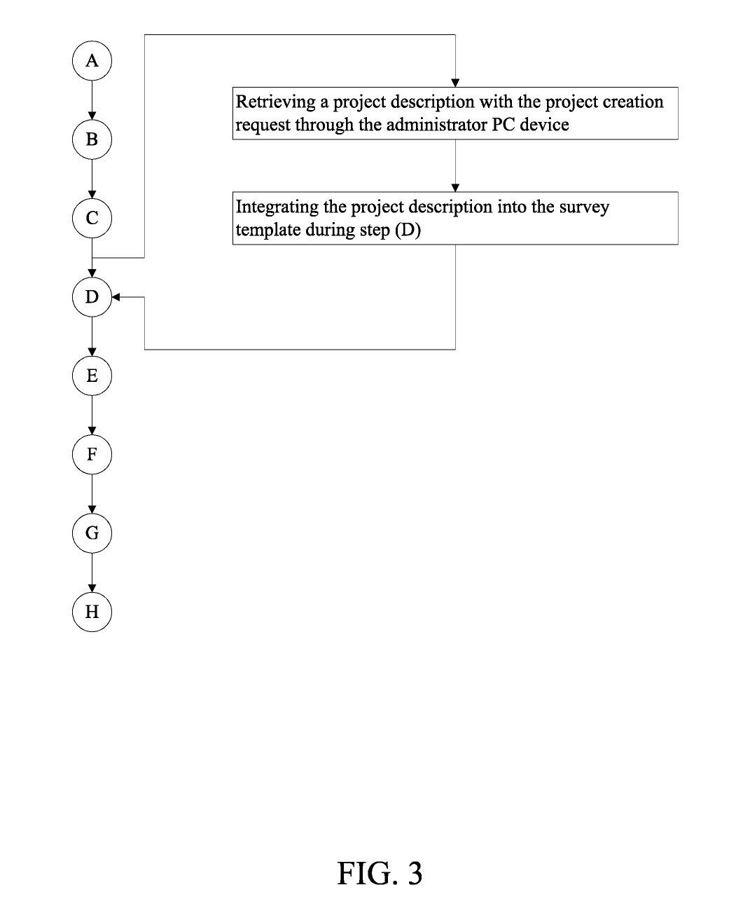

As can be seen in FIG. 3, the method of the present invention is designed to give the administrator freedom to specify what the survey is designed to quantify and the metric used for this quantification. To that end, the overall process of the present invention includes a sub-process that retrieves a project description with the project creation request through the administrator PC device. The project description is a piece of data that the administrator uses to convey what the survey is related to, as well as instructions for the user. The sub-process continues by integrating the project description into the survey template during Step D. This step adds the project description to the survey template so that the user is able to view the project description when filling out the survey.

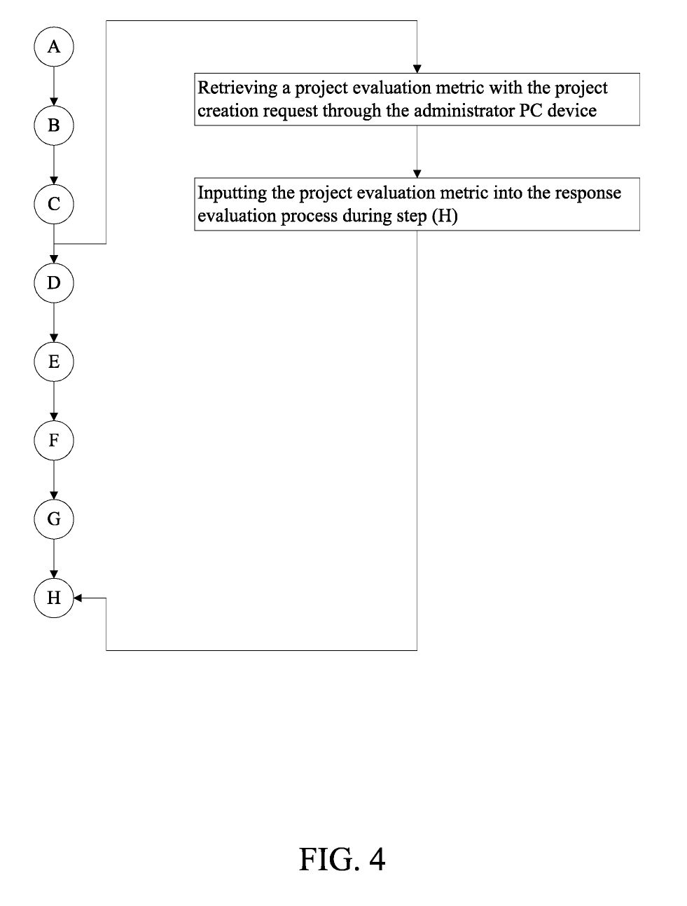

As can be seen in FIG. 4, a separate sub-process of the method of the present invention enables the administrator to specify the metric that will used to evaluate user responses to the survey. To that end, the sub-process begins by retrieving a project evaluation metric with the project creation request through the administrator PC device. The project evaluation metric is an administrator-supplied data point that specifies how the present invention will quantify user response. For example, if the administrator wants to measure the value added to the user, the administrator will define the project evaluation metric as a value measurement. Similarly, if the administrator wants to quantify positive or negative user experiences, then the administrator defines the project evaluation metric as an experience measurement. The sub-process continues by integrating the project evaluation metric into the response evaluation process during Step H. This step is used to flag the survey template with the project evaluation metric so that the response evaluation process employs the appropriate analysis technique.

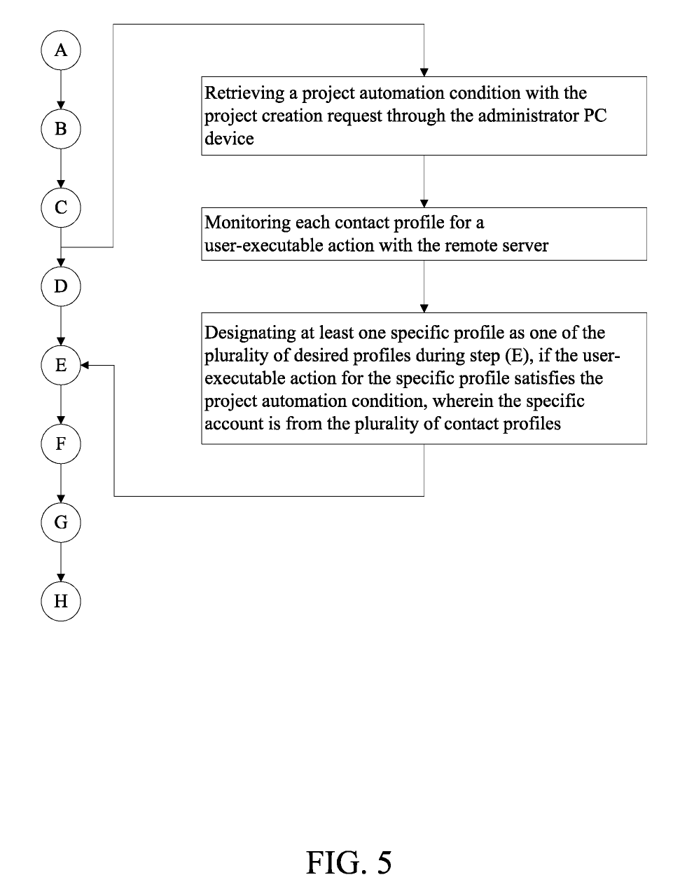

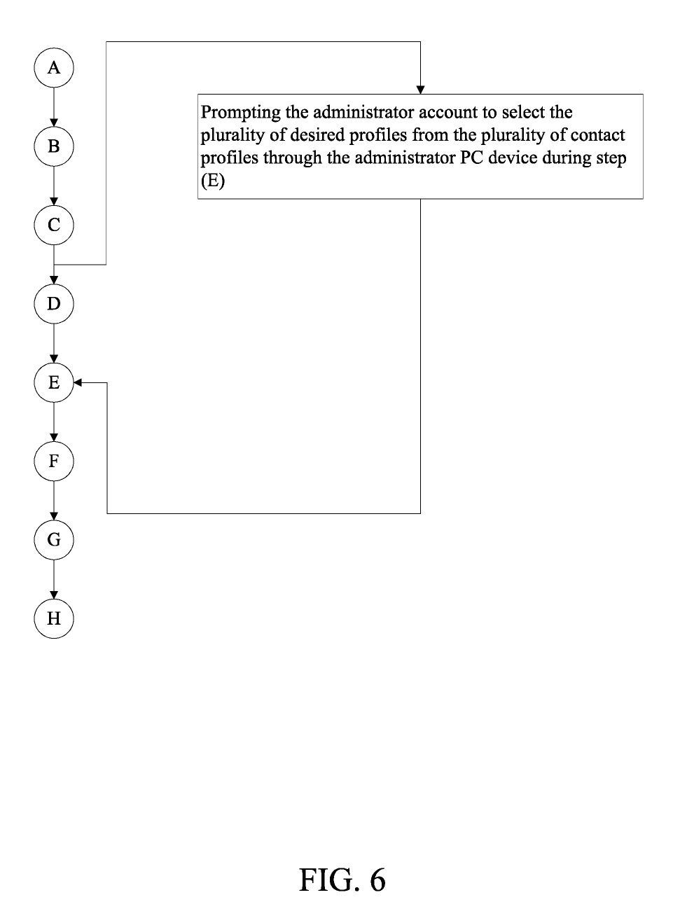

As can be seen in FIG. 5 and FIG. 6, a separate sub-process of the method of the present invention enables the administrator to specify if the survey should be automatically transmitted to the user upon completion of the specific task. To accomplish this, the sub-process begins by retrieving a project automation condition with the project creation request through the administrator PC device. The project automation condition is a conditional statement that the administrator creates to instruct the present invention to transmit the survey template to the user who satisfies the conditional statement. The sub-process continues by monitoring each contact profile for a user-executable action with the remote server. The user-executable action is an operation or action that the user can perform to satisfy the project automation condition. This step is used to monitor the activity of the plurality of users so that the present invention is able to determine if any of the users performs an action that satisfies the project automation condition. The sub-process continues by designating at least one specific profile as one of the plurality of desired profiles during Step E, if the user-executable action for the specific profile satisfies the project automation condition. The specific profile is a contact profile that has performed the user-executable action. As such, the present invention flags the specific profile and automatically transmits the survey template to the associated user. This sub process is used as a tool for automating survey dissemination when the user completes the task. For example, the present invention can be directed to send a survey to every user that completes a purchase through a specific website. Conversely, the method of the present invention includes a separate sub-process that enables the administrator to manually select the users who should receive a survey. To that end, this sub-process entails prompting the administrator account to select the plurality of desired profiles from the plurality of contact profiles through the administrator PC device during Step E.

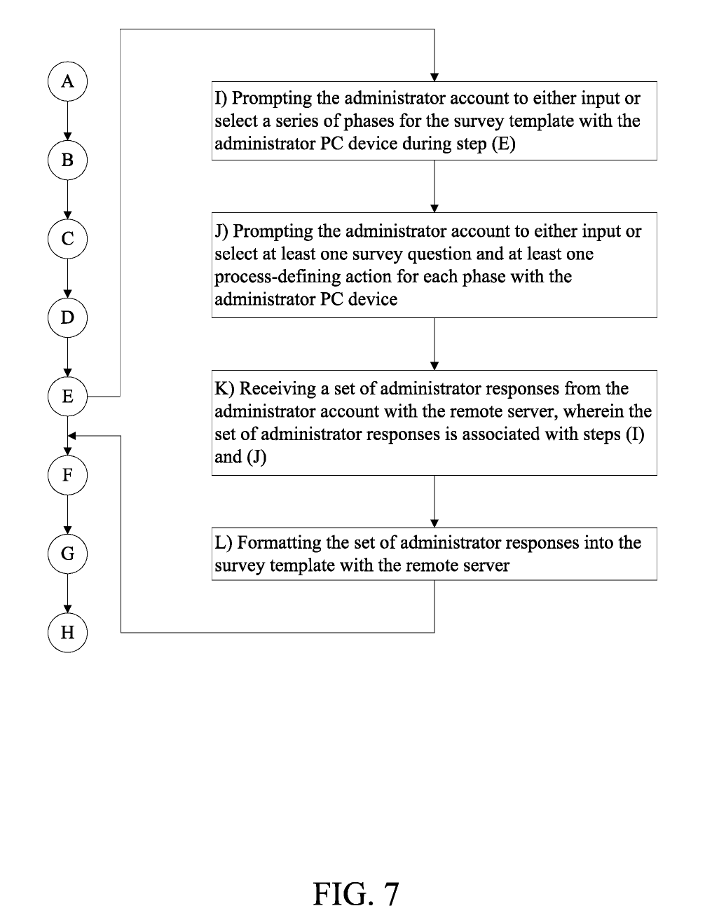

As can be seen in FIG. 7, once the administrator has generated the survey template, the method of the present invention initiates a separate sub-process to format the survey template with the desired survey information. This sub-process begins by prompting the administrator account to either input or select a series of phases for the survey template with the administrator PC device during Step E (Step I). Each phase in the series of phases is a section of the specific task that is being evaluated. For example, when purchasing an item through an online retailer, the first phase might be using a keyword search to find all available merchandise. A second phase might be browsing the available inventory. A third, and final, phase might be performing the transaction to purchase a selected item. The sub-process continues by prompting the administrator account to either input or select a survey question and at least one process-defining action for each phase with the administrator PC device (Step J). The survey question is the question that the administrator includes in the survey template to assess the user's thoughts about a specific phase. The at least one process-defining action is an action that the user must perform to move from one phase to the next. For example, when purchasing an item through an online retailer, clicking the “search” button would be a process-defining action that is required to transition from the first phase to the second phase. This step enables the administrator to define at least one survey question that will be asked about each phase of the task. The sub-process continues by receiving a set of administrator responses from the administrator account with the remote server (Step K). The set of administrator responses is associated with Step I and Step J. Additionally, the set of administrator responses is a collection of responses to the prompts for information that were previously presented to the administrator. This step translates the administrator's vision for the series of phases, the survey question, and the at least one process-defining actions into the data sets that are used to construct the survey. As such, the sub-process continues by formatting the set of administrator responses into the survey template with the remote server (Step L). This step integrates the series of phases and the survey questions associated with each phase into the survey template. That is, Step L uses the set of administrator responses to format the survey template such that the survey template is reconfigured into an interface that can be presented to the plurality of desired users.

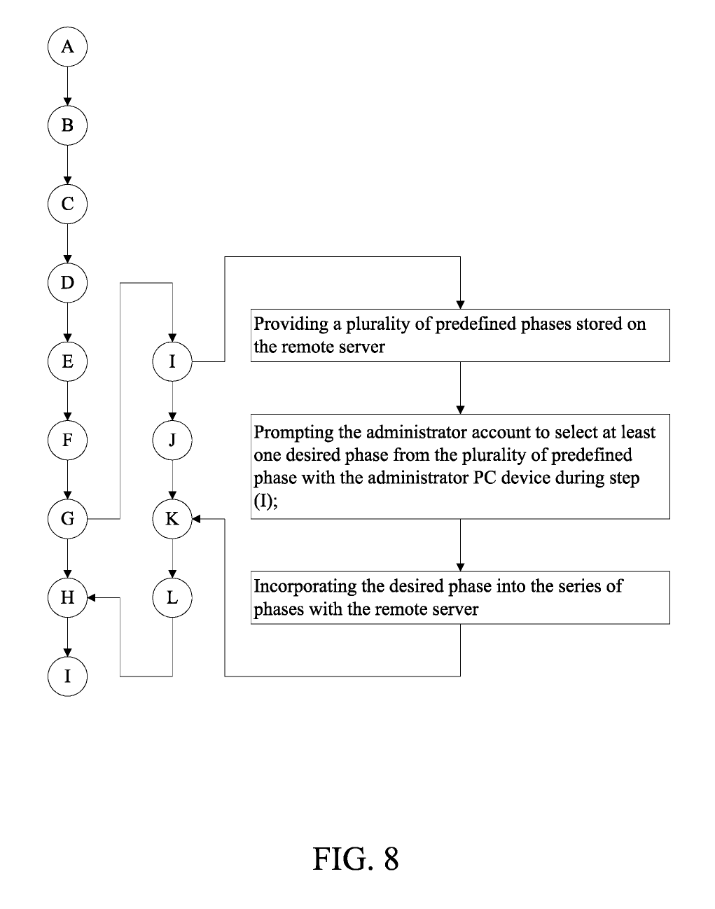

As can be seen in FIG. 8, as denoted above, the administrator is given the option to either input or to select a series of phases for the survey template. To that end, the method of the present invention includes a set of sub-processes for facilitating phase-selection. A first sub-process that facilitates phase-selection begins by providing a plurality of predefined phases stored on the remote server. The plurality of predefined phases is a collection of generic phases that can be used to define a set of generic tasks. The sub-process continues by prompting the administrator account to select at least one desired phase from the plurality of predefined phase with the administrator PC device during Step I. The at least one desired phase is the generic phase that the administrator believes is a part of the task being analyzed. This step enables the administrator to choose the generic phases that will be a part of the task that is being analyzed by the generated survey. The sub-process continues by incorporating the desired phase into the series of phases with the remote server. This step designates the at least one desired phase as a part of the series of phases and includes the at least one desired phase in the set of administrator responses.

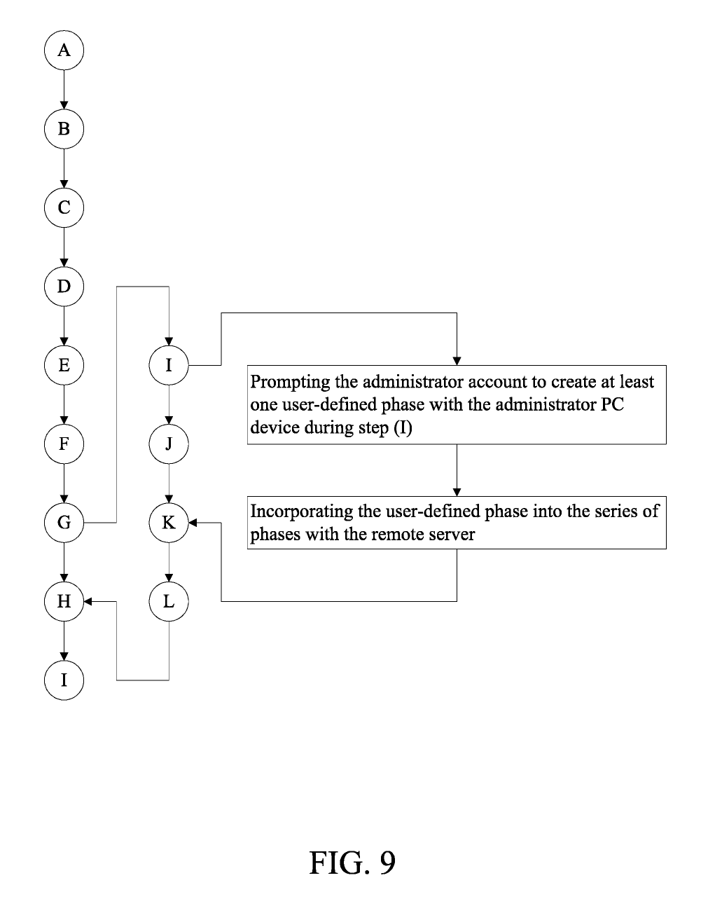

As can be seen in FIG. 9, a second sub-process that facilitates phase-selection enables the administrator to develop at least one unique phase that will be included in the series of phases. This sub-process begins by prompting the administrator account to create at least one user-defined phase with the administrator PC device during Step I. The at least one user-defined phase is a unique phase that the administrator develops for the series of phases. The sub-process continues by incorporating the user-defined phase into the series of phases with the remote server. This step designates the at least one user-defined phase as a part of the series of phases and includes the at least one user-defined phase in the set of administrator responses.

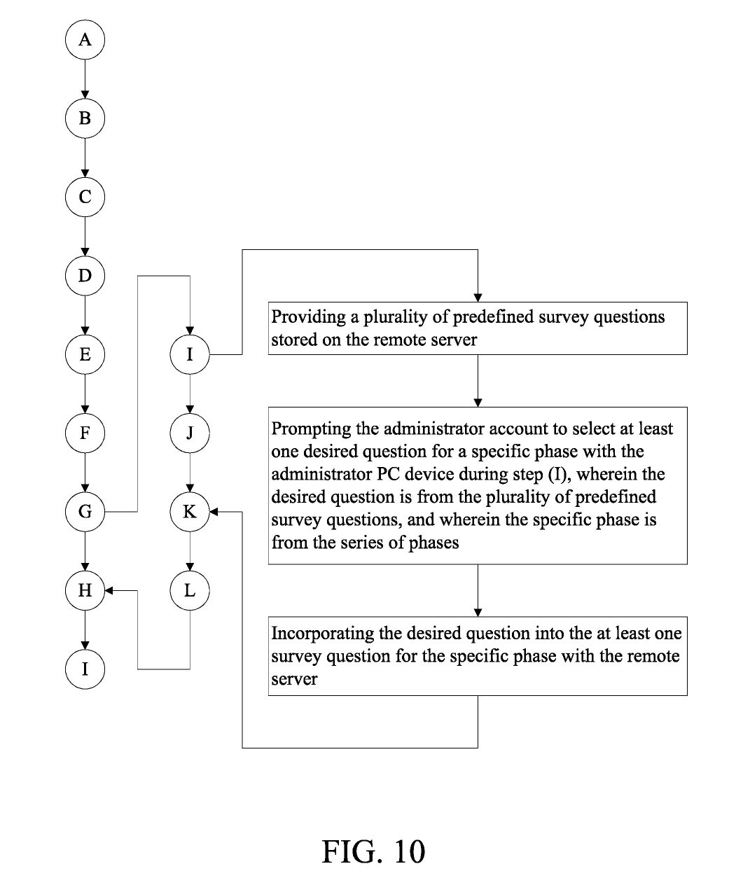

As can be seen in FIG. 10, as denoted above, the administrator is given the option to either input or to select a survey question for each phase in the survey template. To that end, the method of the present invention includes a set of sub-processes for facilitating question-selection. A first sub-process that facilitates question-selection begins by providing a plurality of predefined survey questions stored on the remote server. The plurality of predefined survey questions is a collection of generic questions that can be used to evaluate a set of generic tasks. The sub-process continues by prompting the administrator account to select at least one desired question for a specific phase with the administrator PC device during Step I. The desired question is one of the generic questions contained in the plurality of predefined survey questions that the administrator believes effectively assess the user's response to a specific phase. This step enables the administrator to choose the generic question that will be used to assess the specific phase of the task that is being analyzed by the generated survey. The sub-process continues by incorporating the desired question into the at least one survey question for the specific phase with the remote server. This step designates the desired question as the at least one survey question and includes the desired question in the set of administrator responses.

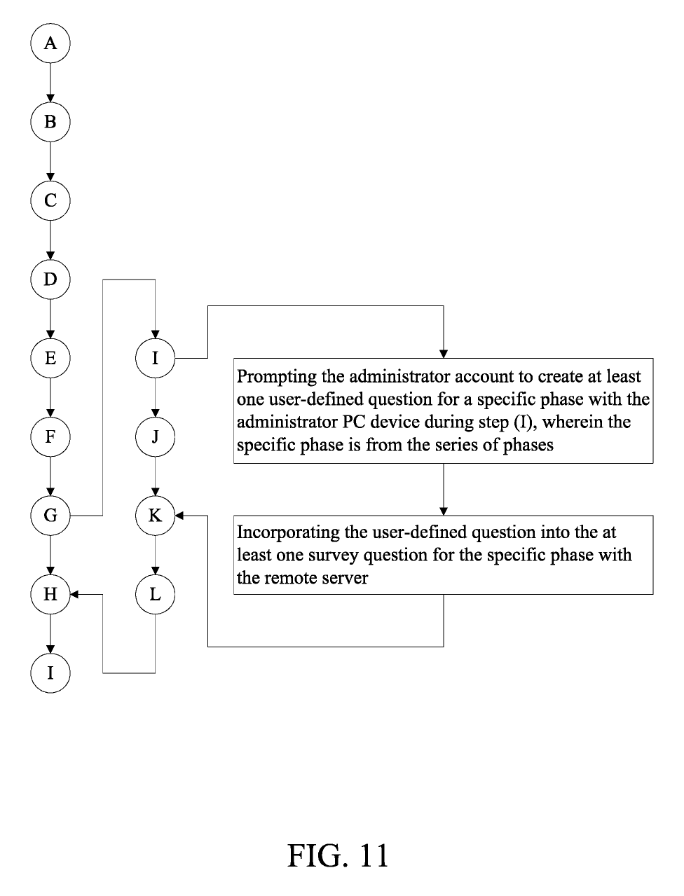

As can be seen in FIG. 11, a second sub-process that facilitates question-selection enables the administrator to develop at least one user-defined question that will be used to assess the user response to a specific phase in the series of phases. This sub-process begins by prompting the administrator account to create at least one user-defined question for a specific phase with the administrator PC device during Step I. The at least one user-defined question is a unique question that the administrator develops to assess the user's response to the specific phase. The sub-process continues by incorporating the user-defined question into the at least one survey question for the specific phase with the remote server. This step designates the at least one user-defined question as the at least one survey question and includes the at least one user-defined question in the set of administrator responses.

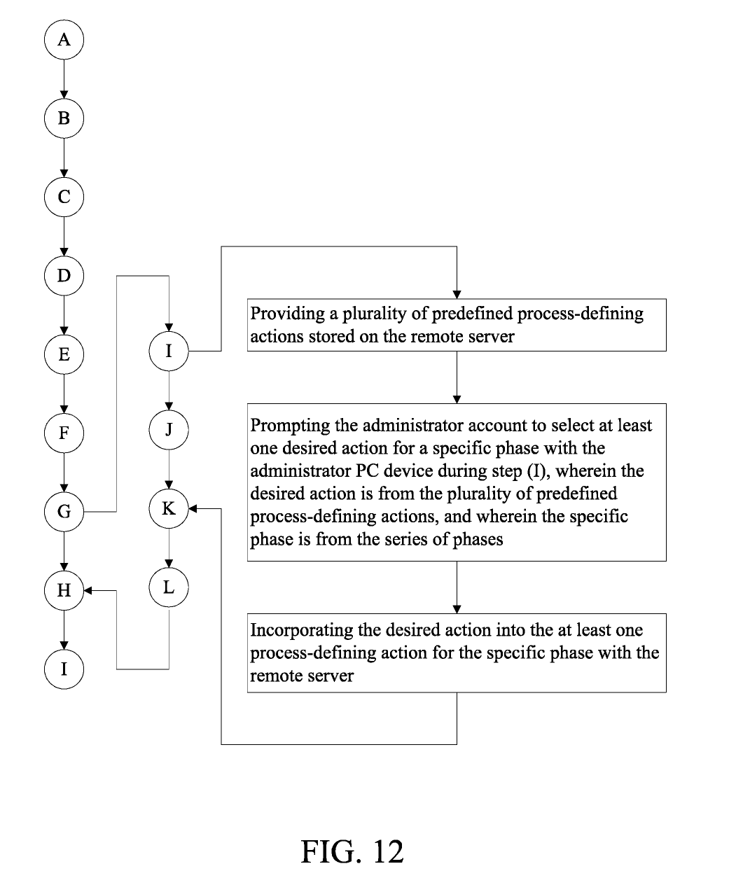

As can be seen in FIG. 12, as denoted above, the administrator is given the option to either input or to select at least one process-defining action for each phase in the survey template. To that end, the present invention includes a set of sub-processes for facilitating action-selection. A first sub-process that facilitates action-selection begins by providing a plurality of predefined process-defining actions stored on the remote server. The plurality of predefined process-defining actions is a collection of generic actions that must be performed when transitioning through a set of phases. The sub-process continues by prompting the administrator account to select at least one desired action for a specific phase with the administrator PC device during Step I. The at least one desired action is one of the generic actions contained in the plurality of predefined process-defining actions that the administrator believes must be completed to transition the user response from a specific phase into a subsequent phase. This step enables the administrator to choose the generic actions that will be used to transition the user out of the specific phase of the task that is being analyzed by the generated survey. The sub-process continues by incorporating the desired action into the at least one process-defining action for the specific phase with the remote server. This step designates the desired action as the at least one process-defining action and includes the at least one process-defining action in the set of administrator responses.

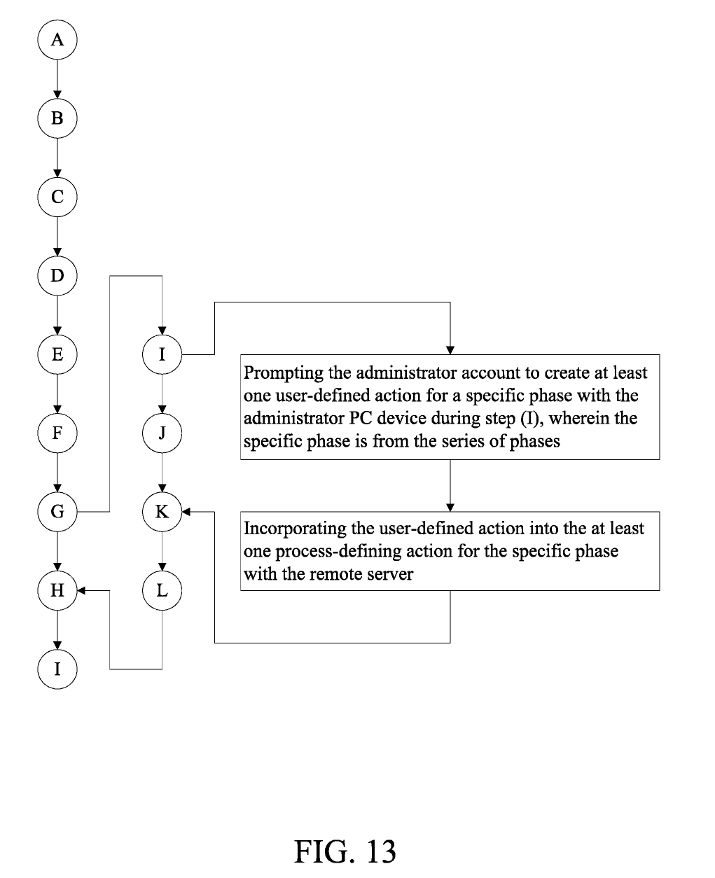

As can be seen in FIG. 13, a second sub-process that facilitates action-selection enables the administrator to develop at least one user-defined question that the user must complete while in a specific phase of the series of phases. This sub-process begins by prompting the administrator account to create at least one user-defined action for a specific phase with the administrator PC device during Step I. The at least one user-defined action is a unique action that the administrator develops to transition the user response from a specific phase into a subsequent phase. The sub-process continues by incorporating the user-defined action into the at least one process-defining action for the specific phase with the remote server. This step designates the at least one user-defined action as the at least one process-defining action and includes the at least one user-defined action in the set of administrator responses.

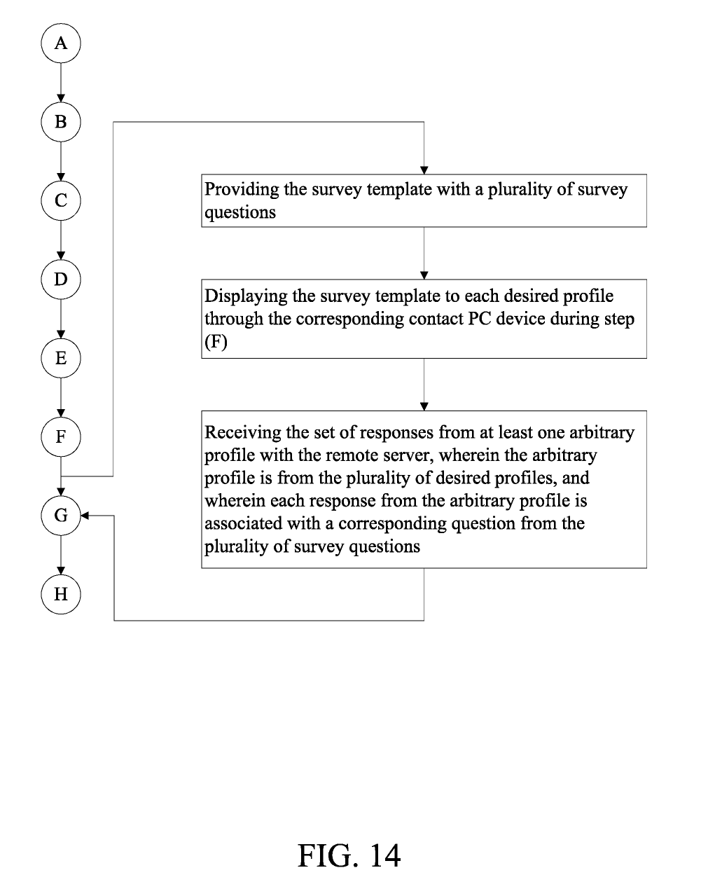

As can be seen in FIG. 14, once the administrator has completed the formatting process, the survey template is sent to the plurality of desired users. The method of the present invention includes a sub-process that enables each desired user to fill out the survey and respond to the administrator. This sub-process begins by providing the survey template with a plurality of survey questions. The completely formatted survey template is made available to each of the desired users as an interactive interface that can be accessed at each desired user's discretion. The sub-process continues by displaying the survey template to each desired profile through the corresponding contact PC device during Step F. This step renders the survey template on the desired user's corresponding contact PC device in an interactive format. As such, the desired user is able to complete the survey by answering the at least one survey questions that is associated with each of the series of phases. Once the desired user has completed the survey and sent in the responses, the sub-process continues by receiving the set of responses from at least one arbitrary profile with the remote server. From the perspective of the remote server, the at least one arbitrary profile is any profile that is associated with a single one of the plurality of desired profiles. As such, the arbitrary profile is the contact profile that is associated with the previously described “desired user”. Moreover, each response included in the set of responses is associated with a corresponding question from the plurality of survey questions. Consequently, the present invention is able to analyze the responses received from individual users and the aggregate responses from the plurality of desired users.

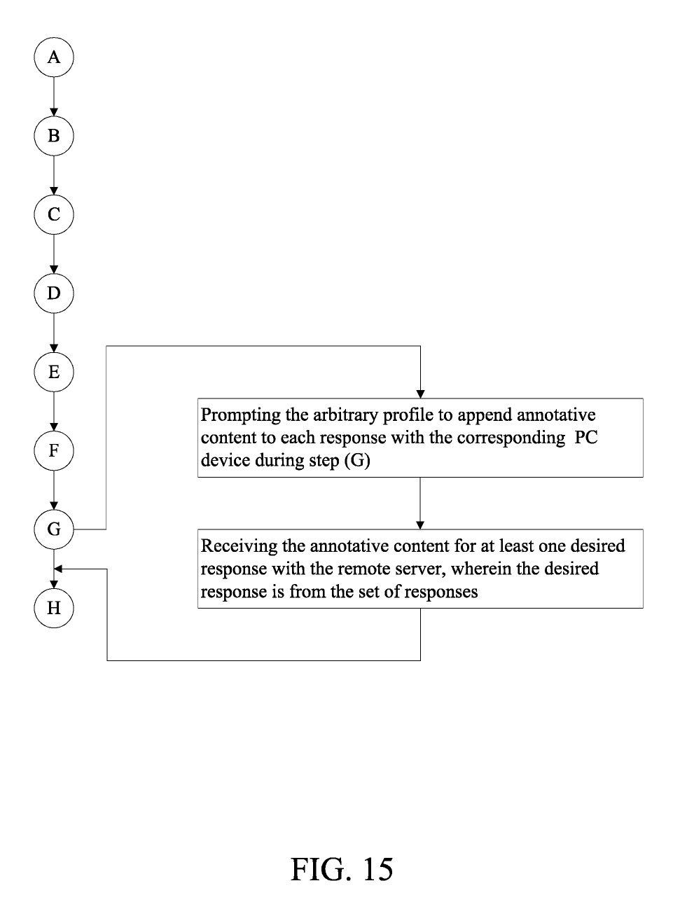

As can be seen in FIG. 15, the method of the present invention also includes a sub-process that enables the user to upload additional content to the set of responses that is sent to the administrator. For example, the user is able to upload content including, but not limited to, videos, pictures, and voice recordings. This sub-process begins by prompting the arbitrary profile to append annotative content to each response with the corresponding contact PC device during Step G. The annotative content is the additional content that the user is able to send to the administrator to supplement the set of responses. The sub-process continues by receiving the annotative content for at least one desired response with the remote server. The desired response is one of the responses that is included in the set of responses to which the user appends the annotative content. This step enables the remote server to associate the correct annotative content with the appropriate responses from the user.

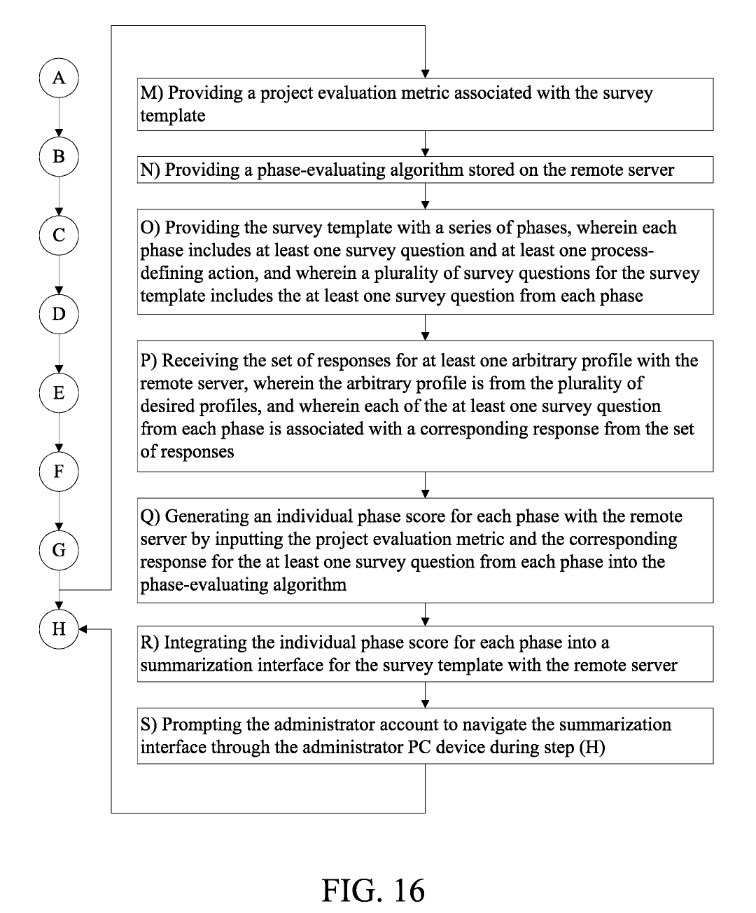

As can be seen in FIG. 16, the method of the present invention includes a sub-process for evaluating survey results and discussing these results among colleagues. To that end, the sub-process begins by providing a project evaluation metric associated with the survey template (Step M). The sub-process continues by providing a phase-evaluating algorithm stored on the remote server (Step N). The phase-evaluation algorithm is a routine that uses the project evaluation metric to form a quantifiable score for each of the responses included in the set of responses that is sent in by each user. The sub-process continues by providing the survey template with a series of phases (Step O). In this step, each phase includes at least one survey question and at least one process-defining action. Additionally, each of the at least one survey question from each phase is associated with a corresponding response from the set of responses. The sub-process continues by receiving the set of responses for at least one arbitrary profile with the remote server (Step P). The arbitrary profile is from the plurality of desired profiles. That is, the arbitrary profile indicates a single user from a plurality of users to whom the survey was sent. Moreover, each of the at least one survey question from each phase is associated to a corresponding response from the set of responses. Step P is used to organize the responses from one or more users that received the survey, such that each response is tied to a corresponding survey question. The sub-process continues by generating an individual phase score for each phase with the remote server by inputting the project evaluation metric and the corresponding response for the at least one survey question from each phase into the phase-evaluating algorithm (Step Q). The individual phase score is a qualitative representation of how a single contact responded to the questions associated with a single phase. Step P and Step Q form a process for evaluating the responses from the plurality of users who responded to the survey. This process is executed for each phase in the series of phases. Once all of the responses from a single user have been used to generate individual phase score for each phase, the process is repeated for each of the remaining users. The sub-process continues by integrating the individual phase score for each phase into a summarization interface for the survey template with the remote server (Step R). The summarization interface is a graphical user interface (GUI) that presents the administrator with a formatted representation of the data gathered by executing the overall method of the present invention. Additionally, the summarization interface presents the administrator with the option to interact with various pieces of data and to execute secondary operations which enhance the quality of analysis that can be gleaned through the method of the present invention. To that end, the sub-process continues by prompting the administrator account to navigate the summarization interface through the administrator PC device (Step S). This step enables the administrator to initiate secondary operations including, but not limited to, sorting the survey data by user groups, sending out the survey results for expert analysis, and initiating direct communication with survey respondents.

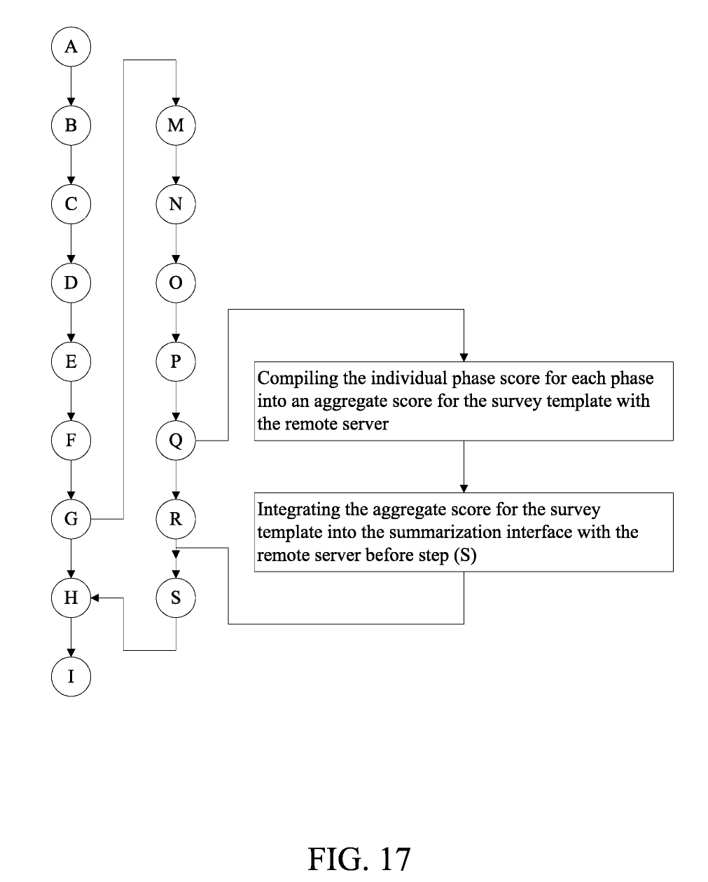

As can be seen in FIG. 17, a separate sub-process of the method of the present invention enables the administrator account to view a graphical representation of the aggregated phase scores from all of the survey respondents. This sub-process begins by compiling the individual phase score for each phase into an aggregate score for the survey template with the remote server. The aggregate score is a quantitative measure of how each phase was scored by each respondent. The sub-process continues by integrating the aggregate score for the survey template into the summarization interface with the remote server before Step S. This step makes the aggregate score for each respondent available for the administrator to access through the summarization interface.

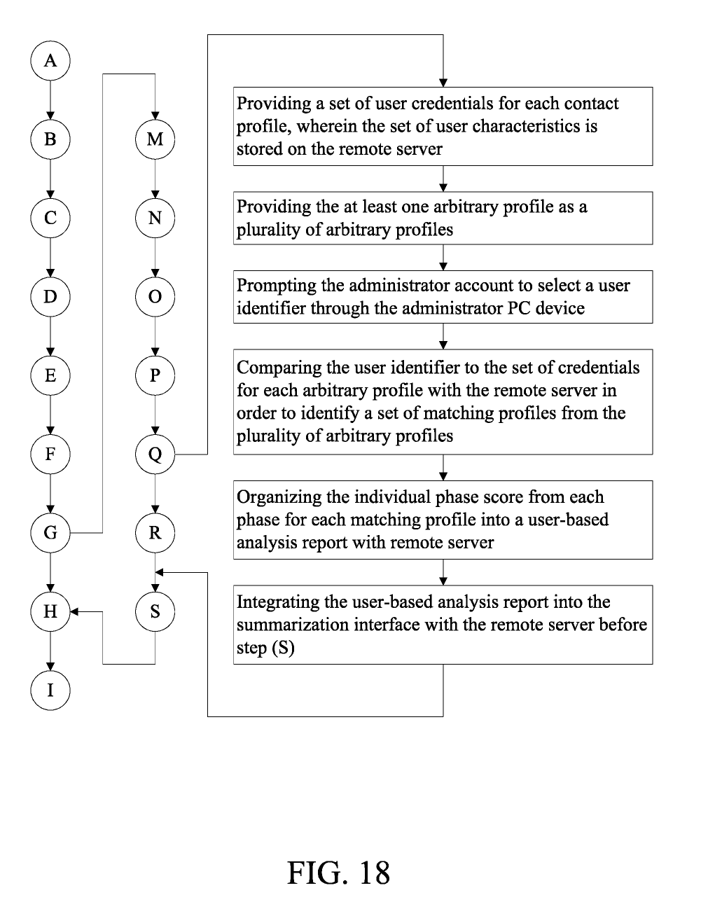

As can be seen in FIG. 18, a separate sub-process of the method of the present invention enables the administrator to sort the responses from the survey respondents into groups of users. For example, the administrator can elect to separate the group of users who are colleagues from the group of users who are customers. This sub-process begins by providing a set of user characteristics for each contact profile. The set of user characteristics is a collection of user identifiers such as, but not limited to, demographic information, occupation, and area of expertise. Additionally, the set of user characteristics includes information that identifies the user and denotes the level of permissions that the contact profile should be granted when using the present invention. In the preferred embodiment of the present invention, the users who receive and respond to the survey are divided into two groups: registered users and unregistered users. The set of user characteristics identifies each contact profile as either a registered user or an unregistered user. The registered users are individuals who are affiliated with the administrator and are given accounts that allow them to log into the present invention. Conversely, the unregistered users are individuals who have no significant affiliation with the administrator. The primary link between the unregistered user and the administrator is the contact profile that simply contains information on how to contact the user when sending, or following-up on, surveys. In a supplementary embodiment of the method of the present invention, the administrator is able to compile a list of preferred registered users. In this embodiment, the administrator can filter the data that is displayed to only contain information that is associated with at least one of the preferred registered users.

As can be seen in FIG. 18, while there are multiple types of contact profiles, the method of the present invention enables the administrator to filter the presented data based on user characteristics. To that end, the sub-process continues by providing the at least one arbitrary profile as a plurality of arbitrary profiles. The sub-process continues by prompting the administrator account to select a user identifier through the administrator PC device. The user identifier is a data point that is used to identify a specific user characteristic. The user identifier enables the administrator to identify information about each of the plurality of contact profiles that includes, but is not limited to, occupation, expertise, and demographics. The sub-process continues by comparing the user identifier to the set of characteristics for each arbitrary profile with the remote server in order to identify a set of matching profiles from the plurality of arbitrary profiles. The set of matching profiles is a group of respondents with contact profiles that have a credential which corresponds to the user identifier. This step is used to filter the data so that the administrator is only presented with survey data from the subset of respondents who satisfy a specific criterion. The sub-process continues by organizing the individual phase score from each phase for each matching profile into a user-based analysis report with remote server. The user-based analysis report is an organized data set that contains the results of the survey analysis that is performed by the present invention. This step formats the individual phase scores from the subset of respondents with contact profiles that align with the user identifier into an accessible report. The sub-process continues by integrating the user-based analysis report into the summarization interface with the remote server before Step S. Now that the data has been filtered into a subset of respondents, this step presents the data to the administrator in a manner that enables the administrator to further manipulate and interpret the survey results. This sub-process enables the administrator to select specific user identifier so that the administrator can gain insights about specific subsets of the respondents. Moreover, by using this sub-process, the administrator is able to compare the survey results between various groups of respondents.

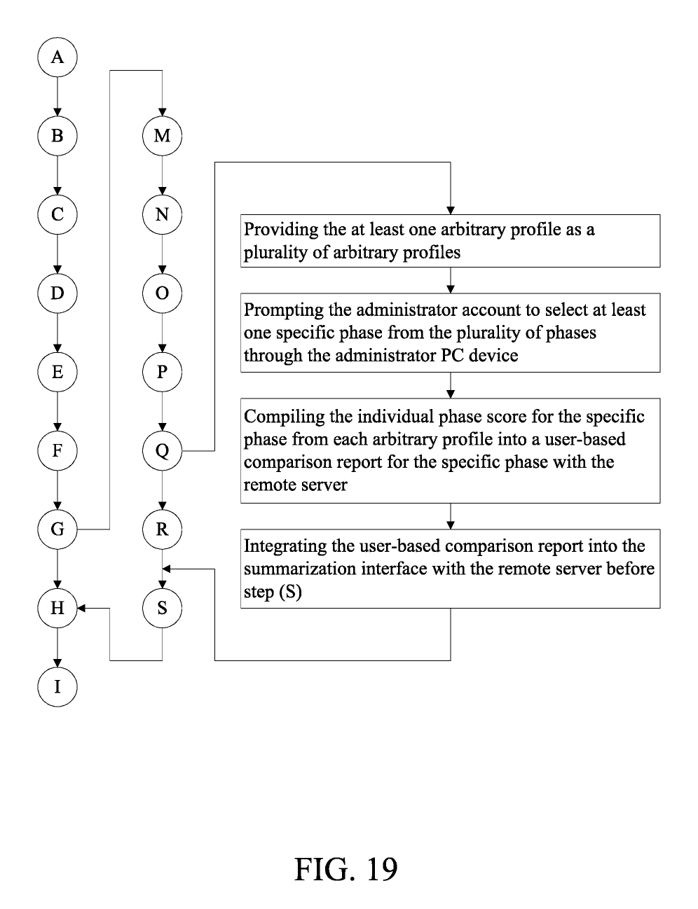

As can be seen in FIG. 19, in addition to comparing the data from subsets of the group of respondents, the method of the present invention is designed to enable the administrator to focus onto the data pertaining to individual phases. To that end, the method of the present invention includes a sub-process that enables the administrator to view and organize the survey data for each phase. This sub-process begins by prompting the administrator account to select at least one specific phase from the plurality of phases through the administrator PC device. This step enables the administrator to select the specific phase about which a closer analysis is desired. The sub-process continues by compiling the individual phase score for the specific phase from each arbitrary profile into a user-based comparison report for the specific phase with the remote server. The user-based comparison report contains survey data that compares the individual phase score from all of the survey respondents. Rather than presenting the administrator with all of the collected survey data, the user-based comparison report narrows the scope to a single phase. The sub-process continues by integrating the user-based comparison report into the summarization interface with the remote server before Step S. This step makes the user-based comparison report available to the administrator.

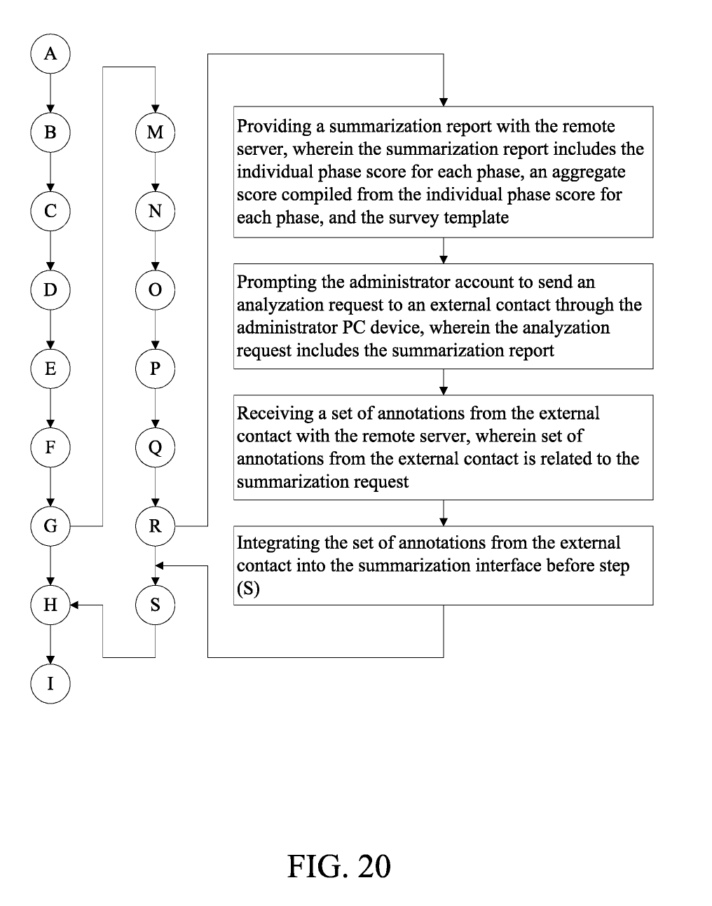

As can be seen in FIG. 20, the method of the present invention includes a sub-process for transmitting survey data to experts and colleagues so that these experts and colleagues can perform additional analysis. This sub-process begins by providing a summarization report with the remote server. The summarization report is a data file that includes the individual phase score for each phase, an aggregate score compiled from the individual phase score for each phase, and the survey template. The sub-process continues by prompting the administrator account to send an analyzation request to an external contact through the administrator PC device. The analyzation request is a message that includes the summarization report and prompts the expert or colleague to append any appropriate annotations or supplementary analysis to the summarization report. The external contact is a colleague or expert to whom the administrator desires to send the summarization report. For example, the administrator could conduct a survey about employee response to a new training program. The administrator could then send the results of the survey to an industrial-organizational (I-O) psychologist for analysis. The I-O psychologist could then read through the data and respond with an expert opinion. Thus, the sub-process continues by receiving a set of annotations from the external contact with the remote server. The set of annotations is the collection of notes that the colleague has made to add value to the information contained in the summarization report. Once the colleague responds, the sub-process continues by integrating the set of annotations from the external contact into the summarization interface before Step S. This step makes the set of annotations from the external contact available to the administrator.

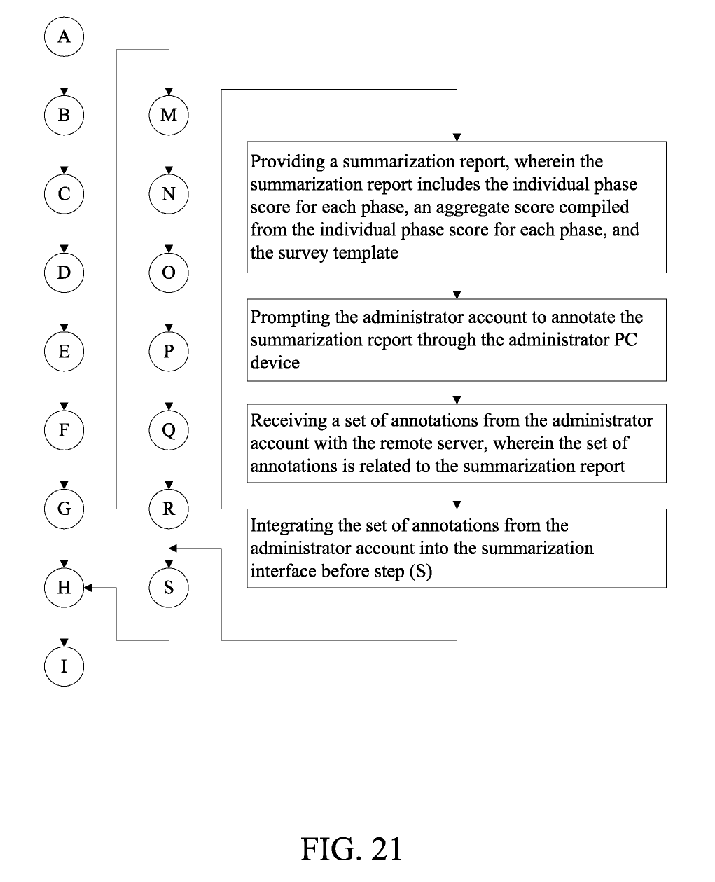

As can be seen in FIG. 21, in addition to colleagues' annotations, the method of the present invention enables the administrator to append personal notes and analysis to the summarization report. To that end, the method of the present invention has a sub-process that begins by prompting the administrator account to annotate the summarization report through the administrator PC device. This allows the administrator to highlight areas of interest and data points that will add value to the analysis performed by the method of the present invention. The sub-process continues by receiving a set of annotations from the administrator account with the remote server. The sub-process continues by integrating the set of annotations from the administrator account into the summarization interface before Step S. Once the administrator has completed annotating the results of the analysis, the set of annotations are sent to the remote server and then integrated into the summarization interface so that the set of annotations for the administrator can be shared with colleagues.

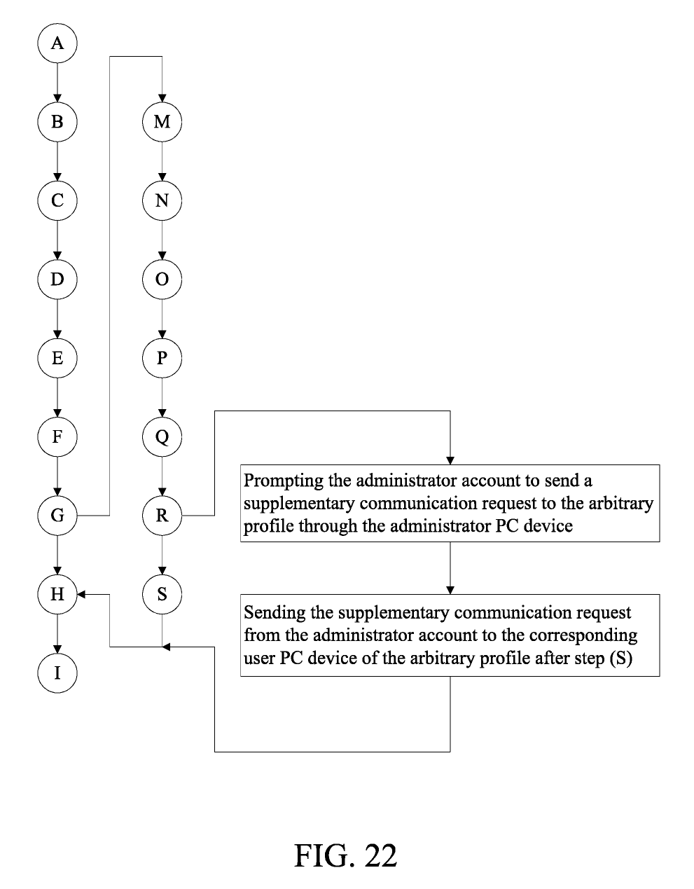

As can be seen in FIG. 22, after the administrator completes the surveying and analysis process, the method of the present invention enables the administrator to reach out to specific respondents to ask follow-up questions. To accomplish this, the method of the present invention includes a sub-process that begins by prompting the administrator account to send a supplementary communication request to the arbitrary profile through the administrator PC device. This step enables the administrator to choose any of the contact profiles who responded to the survey as recipients of a follow-up message. The sub-process continues by sending the supplementary communication request from the administrator account to the corresponding contact PC device of the arbitrary profile after Step S. The recipient is then given the opportunity to accept or deny the supplementary communication request.

Although the invention has been explained in relation to its preferred embodiment, it is to be understood that many other possible modifications and variations can be made without departing from the spirit and scope of the invention as hereinafter claimed.

What is claimed is:

1. A method for documenting a customer's journey using an online survey platform, the method comprises the steps of:
(A) providing an administrator account managed by at least one remote server, wherein the administrator account is associated with an administrator personal computing (PC) device;
(B) providing a plurality of contact profiles managed by the remote server, wherein each contact profile is associated with a corresponding contact PC device;
(C) receiving a project creation request from the administrator account with the remote server;
(D) generating a survey template based on the project creation request with the remote server;
(E) executing a formatting process for the survey template with the remote server, wherein the formatting process identifies a plurality of desired profiles from the plurality of contact profiles;
(F) sending the survey template to each desired profile through the corresponding contact PC device;
(G) prompting each desired profile to send a set of responses for the survey template through the corresponding contact PC device; and
(H) executing a response evaluation process with the remote server, if the remote server receives the set of responses from at least one of the desired profiles.

2. The method for documenting a customer's journey using an online survey platform, the method as claimed in claim 1 comprises the steps of:
retrieving a project description with the project creation request through the administrator PC device; and
integrating the project description into the survey template during step (D).

3. The method for documenting a customer's journey using an online survey platform, the method as claimed in claim 1 comprises the steps of:
retrieving a project evaluation metric with the project creation request through the administrator PC device; and
integrating the project evaluation metric into the response evaluation process during step (H).

4. The method for documenting a customer's journey using an online survey platform, the method as claimed in claim 1 comprises the steps of:
retrieving a project automation condition with the project creation request through the administrator PC device;
monitoring each contact profile for a user-executable action with the remote server; and
designating at least one specific profile as one of the plurality of desired profiles during step (E), if the user-executable action for the specific profile satisfies the project automation condition, wherein the specific profile is from the plurality of contact profiles.

5. The method for documenting a customer's journey using an online survey platform, the method as claimed in claim 1 comprises the step of:
prompting the administrator account to select the plurality of desired profiles from the plurality of contact profiles through the administrator PC device during step (E).

6. The method for documenting a customer's journey using an online survey platform, the method as claimed in claim 1 comprises the steps of:
(I) prompting the administrator account to either input or select a series of phases for the survey template with the administrator PC device during step (E);
(J) prompting the administrator account to either input or select at least one survey question and at least one process-defining action for each phase with the administrator PC device;
(K) receiving a set of administrator responses from the administrator account with the remote server, wherein the set of administrator responses is associated with steps (I) and (J); and
(L) formatting the set of administrator responses into the survey template with the remote server.

7. The method for documenting a customer's journey using an online survey platform, the method as claimed in claim 6 comprises the steps of:
providing a plurality of predefined phases stored on the remote server;
prompting the administrator account to select at least one desired phase from the plurality of predefined phase with the administrator PC device during step (I); and
incorporating the desired phase into the series of phases with the remote server.

8. The method for documenting a customer's journey using an online survey platform, the method as claimed in claim 6 comprises the steps of:
prompting the administrator account to create at least one user-defined phase with the administrator PC device during step (I); and
incorporating the user-defined phase into the series of phases with the remote server.

9. The method for documenting a customer's journey using an online survey platform, the method as claimed in claim 6 comprises the steps of:
providing a plurality of predefined survey questions stored on the remote server;
prompting the administrator account to select at least one desired question for a specific phase with the administrator PC device during step (I), wherein the desired question is from the plurality of predefined survey questions, and wherein the specific phase is from the series of phases; and
incorporating the desired question into the at least one survey question for the specific phase with the remote server.

10. The method for documenting a customer's journey using an online survey platform, the method as claimed in claim 6 comprises the steps of:
prompting the administrator account to create at least one user-defined question for a specific phase with the administrator PC device during step (I), wherein the specific phase is from the series of phases; and
incorporating the user-defined question into the at least one survey question for the specific phase with the remote server.

11. The method for documenting a customer's journey using an online survey platform, the method as claimed in claim 6 comprises the steps of:
providing a plurality of predefined process-defining actions stored on the remote server;
prompting the administrator account to select at least one desired action for a specific phase with the administrator PC device during step (I), wherein the desired action is from the plurality of predefined process-defining actions, and wherein the specific phase is from the series of phases; and
incorporating the desired action into the at least one process-defining action for the specific phase with the remote server.

12. The method for documenting a customer's journey using an online survey platform, the method as claimed in claim 6 comprises the steps of:
prompting the administrator account to create at least one user-defined action for a specific phase with the administrator PC device during step (I), wherein the specific phase is from the series of phases; and
incorporating the user-defined action into the at least one process-defining action for the specific phase with the remote server.

13. The method for documenting a customer's journey using an online survey platform, the method as claimed in claim 1 comprises the steps of:
providing the survey template with a plurality of survey questions;
displaying the survey template to each desired profile through the corresponding contact PC device during step (F); and
receiving the set of responses from at least one arbitrary profile with the remote server, wherein the arbitrary profile is from the plurality of desired profiles, and wherein each response from the arbitrary profile is associated with a corresponding question from the plurality of survey questions.

14. The method for documenting a customer's journey using an online survey platform, the method as claimed in claim 13 comprises the steps of:
prompting the arbitrary profile to append annotative content to each response with the corresponding contact PC device during step (G); and
receiving the annotative content for at least one desired response with the remote server, wherein the desired response is from the set of responses.

15. The method for documenting a customer's journey using an online survey platform, the method as claimed in claim 1 comprises the steps of:
(M) providing a project evaluation metric associated with the survey template;
(N) providing a phase-evaluating algorithm stored on the remote server;
(O) providing the survey template with a series of phases, wherein each phase includes at least one survey question and at least one process-defining action, and wherein a plurality of survey questions for the survey template includes the at least one survey question from each phase;
(P) receiving the set of responses for at least one arbitrary profile with the remote server, wherein the arbitrary profile is from the plurality of desired profiles, and wherein each of the at least one survey question from each phase is associated with a corresponding response from the set of responses;
(Q) generating an individual phase score for each phase with the remote server by inputting the project evaluation metric and the corresponding response for the at least one survey question from each phase into the phase-evaluating algorithm;
(R) integrating the individual phase score for each phase into a summarization interface for the survey template with the remote server; and
(S) prompting the administrator account to navigate the summarization interface through the administrator PC device during step (H).

16. The method for documenting a customer's journey using an online survey platform, the method as claimed in claim 15 comprises the steps of:
compiling the individual phase score for each phase into an aggregate score for the survey template with the remote server; and
integrating the aggregate score for the survey template into the summarization interface with the remote server before step (S).

17. The method for documenting a customer's journey using an online survey platform, the method as claimed in claim 15 comprises the steps of:
providing a set of user characteristics for each contact profile, wherein the set of user characteristics is stored on the remote server;
providing the at least one arbitrary profile as a plurality of arbitrary profiles;
prompting the administrator account to select a user identifier through the administrator PC device;
comparing the user identifier to the set of user characteristics for each arbitrary profile with the remote server in order to identify a set of matching profiles from the plurality of arbitrary profiles;
organizing the individual phase score from each phase for each matching profile into a user-based analysis report with the remote server; and
integrating the user-based analysis report into the summarization interface with the remote server before step (S).

18. The method for documenting a customer's journey using an online survey platform, the method as claimed in claim 15 comprises the steps of:
providing the at least one arbitrary profile as a plurality of arbitrary profiles;
prompting the administrator account to select at least one specific phase from the plurality of phases through the administrator PC device;
compiling the individual phase score for the specific phase from each arbitrary profile into a user-based comparison report for the specific phase with the remote server; and
integrating the user-based comparison report into the summarization interface with the remote server before step (S).

19. The method for documenting a customer's journey using an online survey platform, the method as claimed in claim 15 comprises the steps of:
providing a summarization report with the remote server, wherein the summarization report includes the individual phase score for each phase, an aggregate score compiled from the individual phase score for each phase, and the survey template;
prompting the administrator account to send an analyzation request to an external contact through the administrator PC device, wherein the analyzation request includes the summarization report;
receiving a set of annotations from the external contact with the remote server, wherein set of annotations from the external contact is related to the summarization request; and
integrating the set of annotations from the external contact into the summarization interface before step (S).

20. The method for documenting a customer's journey using an online survey platform, the method as claimed in claim 15 comprises the steps of:
providing a summarization report, wherein the summarization report includes the individual phase score for each phase, an aggregate score compiled from the individual phase score for each phase, and the survey template;
prompting the administrator account to annotate the summarization report through the administrator PC device;
receiving a set of annotations from the administrator account with the remote server, wherein the set of annotations is related to the summarization report; and
integrating the set of annotations from the administrator account into the summarization interface before step (S).

21. The method for documenting a customer's journey using an online survey platform, the method as claimed in claim 15 comprises the steps of:
prompting the administrator account to send a supplementary communication request to the arbitrary profile through the administrator PC device; and
sending the supplementary communication request from the administrator account to the corresponding contact PC device of the arbitrary profile after step (S).
